(19) United States
(12) Patent Application Publication
(10) Pub. No.: US 2026/0298541 A1
(43) Pub. Date: Oct. 1, 2026

(54) SCRAP DRYER AND PRE-HEATER APPARATUS FOR ELECTRIC ARC FURNACE

(71) Applicant: SSAB Enterprises, LLC, Mobile, AL (US)

(72) Inventor: Cache C. Folkman, Bettendorf, IA (US)

(21) Appl. No.: 19/092,932

(22) Filed: Mar. 27, 2025

(51) Int. Cl. F27D 13/00; F27D 19/00

(52) U.S. Cl. CPC F27D 13/002; F27D 19/00; F27D 2019/0003

(57) ABSTRACT

A scrap metal bucket for storing and transporting scrap metal to be added to a melting furnace, such as an Electric Arc Furnace (“EAF”). The scrap metal bucket of the present invention includes a drying and preheating subassembly including a port for connection to a feed line to introduce hot gas, air, or other heated fluids into the scrap bucket to warm and dry scrap metal before introduction into an EAF, to eliminate water, ice and snow from the scrap metal prepositioned within the scrap bucket. The subassembly includes apertures in a bottom plate of the bucket, through which a series of nozzles and tubes feed hot gas, air or other gases to heat the interior of the bucket together with the scrap metal, to remove contaminant elements from the steel making process before introducing the scrap metal into the melting furnace.

### BACKGROUND

Electric arc furnaces (“EAFs”) are used in many steel making processes, during which scrap metal is melted and undesired impurities are removed. Scrap metal piles are often located outside, where the scrap metal is exposed to the elements. In some areas of the world where steel is produced, scrap metal may be exposed to cold, sometimes freezing temperatures, snow, ice, and rainfall. During production, scrap metal is loaded from scrap metal piles into scrap metal buckets. Scrap metal is transported from scrap metal piles to an EAF via such a scrap metal bucket. However, before entering into an EAF, scrap metal should be dry. Scrap metal that has regions of water, ice or snow mixed in with the scrap metal upon introduction into an EAF could affect the EAF process and product. Depending on the amount of these impurities, molten contents can react violently or become unstable. It is therefore necessary to warm, dry, and/or preheat scrap metal when such scrap metal has been exposed to water, snow, or ice under cold or freezing temperatures. The present invention offers a solution for designing or retrofitting a scrap metal bucket with a system and method for preheating and drying scrap metal in preparation for introduction into an EAF.

### SUMMARY OF THE INVENTION

The present invention comprises an apparatus and a method for preheating and drying metal scrap contained within a scrap bucket—prior to the introduction of that scrap into a melting furnace process. An apparatus for pre-heating and drying metal scrap contained within a metal scrap bucket utilized as part of a melting furnace process may, in one example, include a continuous housing having therewithin a contiguous side-wall. The apparatus may further include a clam-shell base having a first door pivotably attached to the continuous housing adjacent said contiguous side-wall and a second door pivotably attached to the contiguous side-wall. The apparatus may further include an interior defined by the contiguous side-wall and the clam-shell base; and a plurality of nozzles positioned within the clam-shell base to enable the introduction of a heated gas into and through the scrap contained within the bucket to remove moisture, ice and snow from within the bucket, prior to the introduction of the scrap from the bucket into the melting furnace.

In an example, the apparatus may further include a controller configured to direct and control an amount of said heated gas into the interior of the bucket from the plurality of nozzles. The apparatus may further include at least one temperature sensor configured to generate a signal indicative of a temperature of the interior wherein the controller commands the introduction and cessation of heated gas into the scrap bucket based on the generated signal. The amount of gas commanded by the controller may be based on a pre-determined amount of heating power. The amount of gas commanded by the controller may be configured to melt ice and snow within the interior of the bucket as well as to evaporate pools of liquids from therewithin.

In an example, the apparatus may include a plurality of openings in the clam shell base, and an opening may be associated with each of the plurality of nozzles, and one or more of said openings in the interior may be substantially trapezoidal in shape. In the example, the clam-shell base may include a center line defined by a meeting of the first door and the second door, the opening of each of the plurality of nozzles has an anterior edge and a posterior edge, the anterior edge and the posterior edge being parallel and defined, relative to the center line, and a length of the anterior edge may be greater than a length of the posterior edge.

In an example, the amount and temperature of the gas introduced into the scrap bucket is insufficient to materially change the state of the metal scrap within the interior of the scrap bucket.

In an example, a method for pre-treating scrap, may include loading a bucket with the scrap, the bucket comprising a base having a first door and a second door. The method may further include introducing, via at least one nozzle located in the base, an amount of hot gas into the bucket to evacuate moisture, snow, ice or water from within the bucket prior to releasing the scrap into a melting furnace. The method may further include positioning the bucket over a metal formation furnace; and opening the first door and the second door to cause the scrap to fall into the furnace.

In the example, the base may be a clam-shell structure defined by the first door and the second door. The method may further include determining a temperature of the scrap via a temperature sensor; and ceasing the introduction of the amount of hot gas based on attainment of the determined temperature. In the example, the amount of hot gas introduced into the scrap bucket is based upon a pre-determined amount of heating power. In the example, the amount of gas is configured to evaporate moisture and to melt ice and snow positioned within the bucket, while increasing the ambient temperature of the scrap metal within the scrap bucket.

In the example method, an opening of the at least one nozzle into the bucket is substantially trapezoidal in shape, in which the widest edge of the trapezoid faces downwardly upon opening of the clamshells. In an example, the amount of gas is insufficient to materially change the state of the scrap metal located within the interior.

### BRIEF DESCRIPTION OF THE DRAWINGS

FIG. 1A is a front elevational view of an example scrap metal bucket of the prior art, in a first, closed configuration.

FIG. 1B is a top plan view of the prior art scrap metal bucket illustrated in FIG. 1A.

FIG. 1C is a side perspective view of the prior art scrap metal bucket illustrated in FIG. 1A in a second, open configuration.

FIG. 2A is a top perspective view of an example scrap metal bucket having a preheating and drying assembly attached to both the first and second clamshell bottoms of the scrap metal bucket, showing the first and second clamshell bottoms in a first closed configuration.

FIG. 2B is a top perspective view of the example scrap metal bucket illustrated in FIG. 2A, in which the clamshell halves having heating subassemblies have been rotated upwardly to a second configuration, in which the clamshell bottoms are opened.

FIG. 3A is a front elevation view of the example scrap metal bucket of FIG. 2A in its first closed configuration.

FIG. 3B is a front elevation view of the example scrap metal bucket of FIG. 2B in its second opened configuration.

FIG. 4A is a top plan view of the example scrap metal bucket of FIG. 2A in its first closed configuration.

FIG. 4B is a top plan view of the example scrap metal bucket of FIG. 2B in its second opened configuration.

FIG. 5 is a top perspective, partial detail view of the linkage assembly of the example scrap metal bucket illustrated in FIGS. 2A-B, in its opened configuration.

FIG. 6 is a rear side elevation and partial detail view of the linkage assembly of the example scrap metal bucket illustrated in FIGS. 2A-B, in the second configuration.

FIG. 7 is a rear perspective, partial detail view of the scrap preheating and drying assembly of the scrap metal bucket in its closed position, according to the present invention.

FIG. 8 is a top plan, partial detail view of the scrap preheating and drying assembly of the scrap metal bucket according to the present invention.

FIG. 9A is a side perspective, partial detail view of a portion of the scrap preheating and drying assembly of the scrap metal bucket according to the present invention.

FIG. 9B is a perspective view of a portion of the example scrap metal bucket illustrated in FIG. 9A, showing further detail of an example tube, nozzle, and aperture assembly.

FIG. 9C is a perspective view of a portion of the example scrap metal bucket illustrated in FIG. 9A, showing further detail of an example tube, nozzle, and aperture assembly.

FIG. 9D is a perspective view of a portion of the example scrap metal bucket illustrated in FIG. 9A, showing further detail of an example tube, nozzle, and aperture assembly.

FIG. 10 is a bottom plan, partial detail view of the scrap preheating and drying assembly of the scrap metal bucket according to the present invention, showing a portion of the heating assembly.

FIG. 11A is a perspective view of the scrap metal bucket and preheating and drying subassembly illustrated in FIGS. 2A-B in its first closed position.

FIG. 11B is a perspective view of the scrap metal bucket and preheating and drying subassembly illustrated in FIGS. 2A-B in its second open position configuration.

FIG. 12 is a perspective view of the overall scrap metal bucket apparatus for orientation to and relocation over an electric arc furnace to charge scrap into the furnace, for subsequent hoisting over, release into, and melting within the furnace.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure the important aspects of the present invention.

Generally speaking, various embodiments of the invention provide for a scrap metal bucket that is able to pre-heat and dry scrap metal which may have been exposed to rain, snow, water, and cold temperatures, and related systems and methods, prior to the introduction of that scrap metal over and into an electric arc furnace. In some embodiments, the scrap metal bucket includes a clamshell base with a plurality of nozzles attached thereto, the nozzles configured to deliver hot gases to the interior of the bucket, the hot gases being capable of heating and drying the contents of the bucket before introduction of the bucket's contents into the EAF.

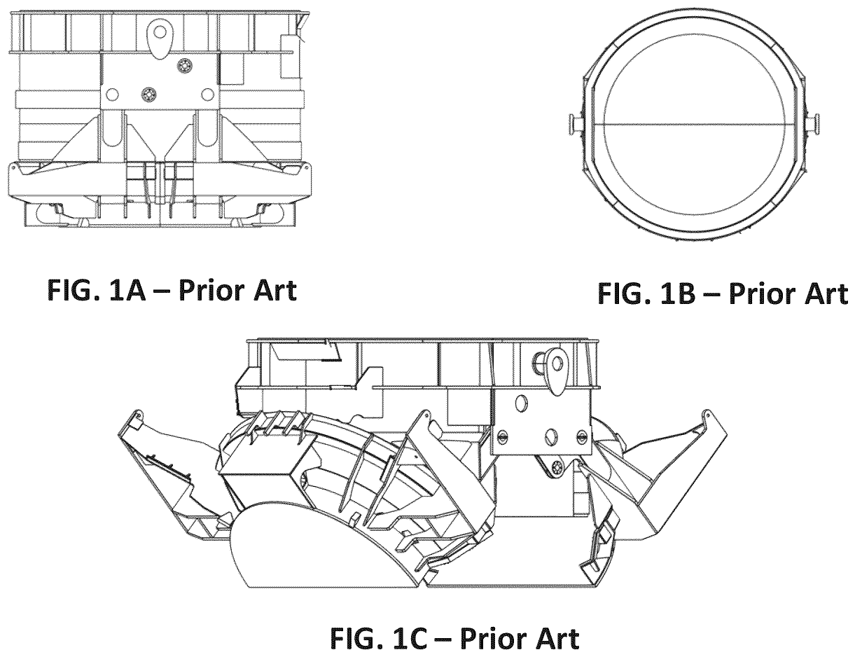

FIGS. 1A-1C illustrate an example scrap metal bucket of the prior art. FIG. 1A is a front elevational view of an example scrap metal bucket of the prior art. As illustrated in FIG. 1A, a scrap metal bucket may have a main body that is a continuous housing having therewithin a contiguous sidewall. The scrap metal bucket of the prior art has a clamshell door assembly at the bottom of the bucket, wherein two doors, each door being one half of the clamshell, come together at a centerline of the housing to form a bottom for an enclosed scrap metal bucket.

FIG. 1B is a top plan view of the example scrap metal bucket of the prior art illustrated in FIG. 1A. As illustrated in FIG. 1B, the clamshell doors provide a bottom to the scrap metal bucket, allowing the bucket to collect and retain scrap metal which is deposited into the bucket. Each clamshell door is rotatably connected to the scrap metal bucket sidewall, such that the clamshell door may rotate or pivot open to displace the bottom of the scrap metal bucket and empty the contents of the scrap metal bucket to a location beneath the bucket. The clamshell doors may, in a first configuration and without any external forces applied, meet at a centerline of the scrap metal bucket in a “closed” position.

FIG. 1C is a front perspective view of the example scrap metal bucket of the prior art illustrated in FIG. 1A. As illustrated in FIG. 1C, the clamshell doors may have at least one, but in certain examples, may contain many attachment points to which chains, ropes, or the like may be attached to the clamshell doors. The chains, ropes, or the like may pull on the clamshell doors and rotate them from the first “closed” configuration to a second “open” configuration in which the bottom of the scrap bucket formed by the clamshell doors is displaced to an open position, in which the contents of the scrap bucket, upon positioning over an EAF, are released from the bucket towards and into the EAF. The scrap metal bucket of the prior art may further contain a linkage assembly which attaches either or both of the first and second clamshell door to the sidewall of the scrap metal bucket. In this example of the prior art, the linkage assembly may attach both the first and second clamshell doors to the sidewall of the scrap metal bucket, and may attach the first clamshell door to the second clamshell door, such that pulling open one of the first or second clamshell door may cause the other of the first or second clamshell door to similarly rotate to its open position.

The scrap metal bucket of the prior art may also contain lifting lugs which are used to connect machinery to the bucket and transport the bucket to and from different locations. For example, the scrap metal bucket may take up too much space inside a steel mill when the bucket is not being used. In this example, the scrap metal bucket is placed outside of an EAF using machinery, so that scrap metal may be preliminarily placed into the bucket, with the bucket providing storage for the scrap metal before entering into the mill. When the mill is ready to use the scrap metal and/or when the bucket is full, machinery may be used to lift the scrap metal bucket by its lifting lugs to bring the contents of the scrap metal bucket, bucket and all, into the mill—to a position above the EAF itself. However, when the scrap metal bucket is placed outside for storage and collecting scrap metal to be used in the mill, the bucket and its scrap metal may be exposed to rain, water, ice, and/or snow which is at or below freezing temperatures. Before being placed into a furnace for melting the metal, the scrap metal should be dry and any water, snow, or ice should be melted off and released from the bucket to enable the scrap metal to dry and/or moisture, ice or snow to evaporate, before introducing the scrap metal into the EAF.

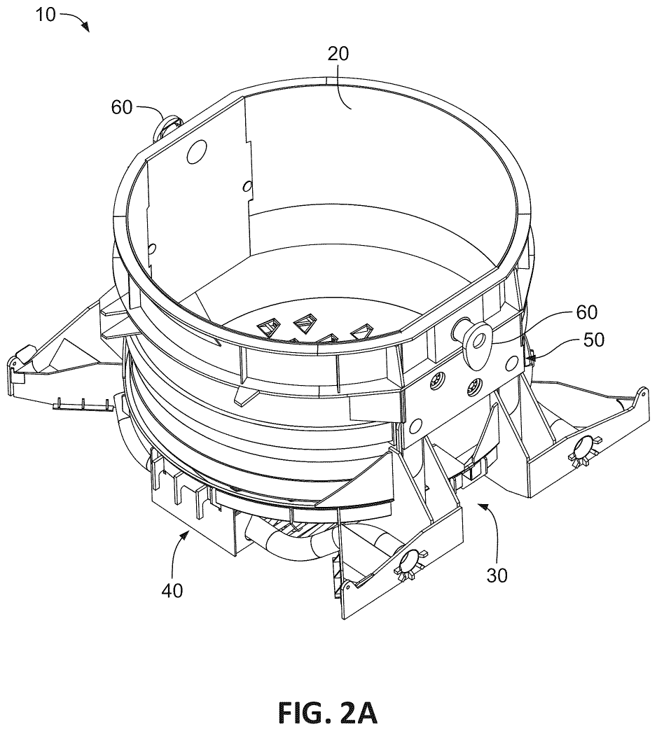

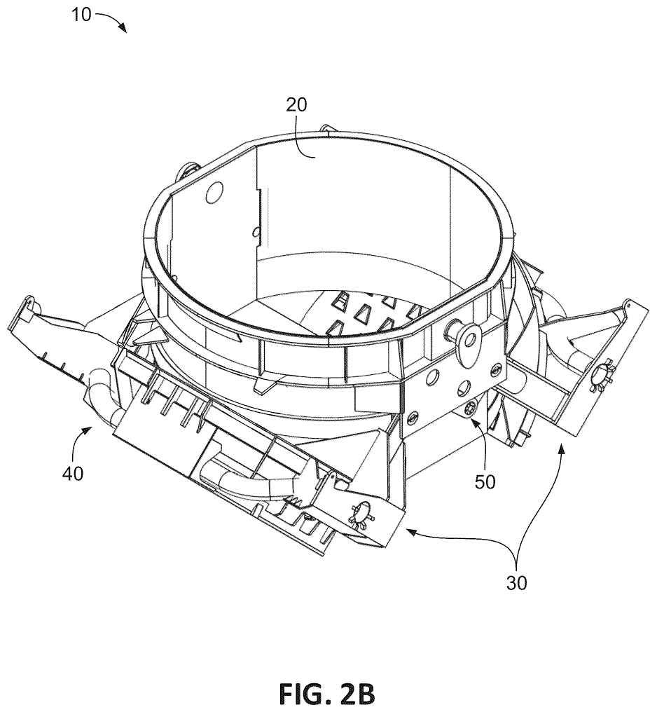

FIG. 2A is an illustration of example scrap metal bucket 10 configured to pre-heat and dry scrap metal before introduction into an EAF, in accordance with various embodiments of the present disclosure. FIG. 2A is a perspective view of scrap metal bucket 10 in a first embodiment. In the illustrated example, bucket 10 includes sidewall 20. Bucket 10 may further include clamshell bottom assembly 30, pre-heating and drying assembly 40, and linkage assembly 50. Bucket 10 may further include lifting lugs 60 to which lifting machinery may be attached or coupled to move and/or transport bucket 10. In the example illustrated in FIG. 2A, linkage assembly 50 and clamshell bottom assembly 30 are in a first, closed position, in which clamshell assembly 30 meets sidewall 20 to form a bottom of scrap metal bucket 10.

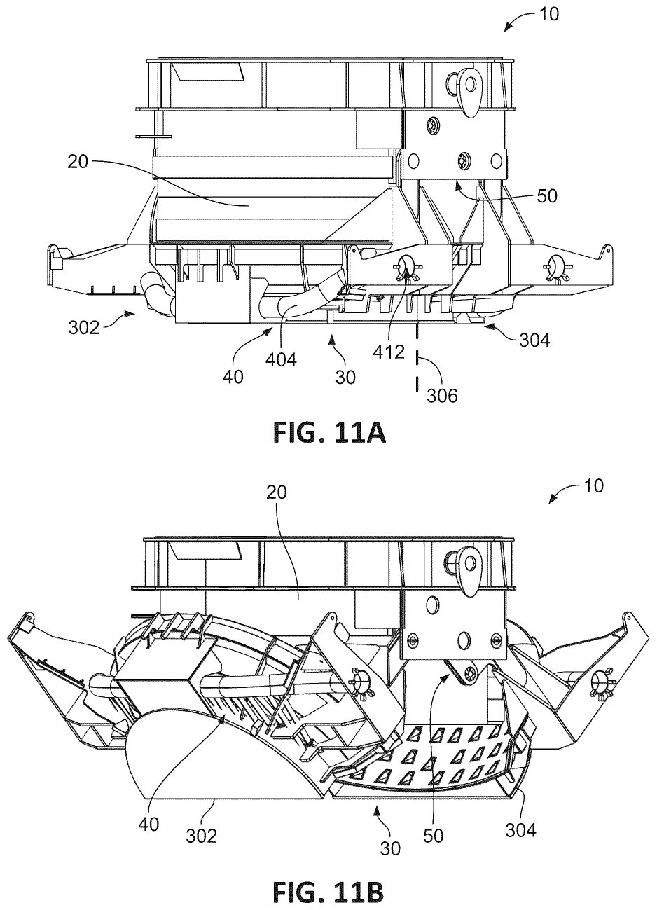

FIG. 2B is an illustration of the example scrap metal bucket 10 of FIG. 2A in its second, open position. FIGS. 11A-B are illustrations of the example scrap metal bucket 10 of FIG. 2A in the second open configuration, showing additional detail of the scrap drying and preheating assembly 40. In the illustrated example, linkage assembly 50 and clamshell bottom assembly 30 are in a second, open position, where clamshell assembly 30 pivots about linkage assembly 50 to separate clamshell assembly 30 to open the bottom of scrap metal bucket 10. As shown in FIG. 2B, and in additional detail in FIGS. 11A-B, pre-heating and drying subassembly 40 may be mechanically fixed to the bottom or near the bottom of clamshell assembly 30 such that, when clamshell assembly 30 pivots about linkage assembly 50 to separate clamshell assembly 30, pre-heating and drying subassembly 40 may likewise pivot and separate in fixed positional relationship with clamshell assembly 30, to provide an unobstructed opening at the bottom of scrap metal bucket 10.

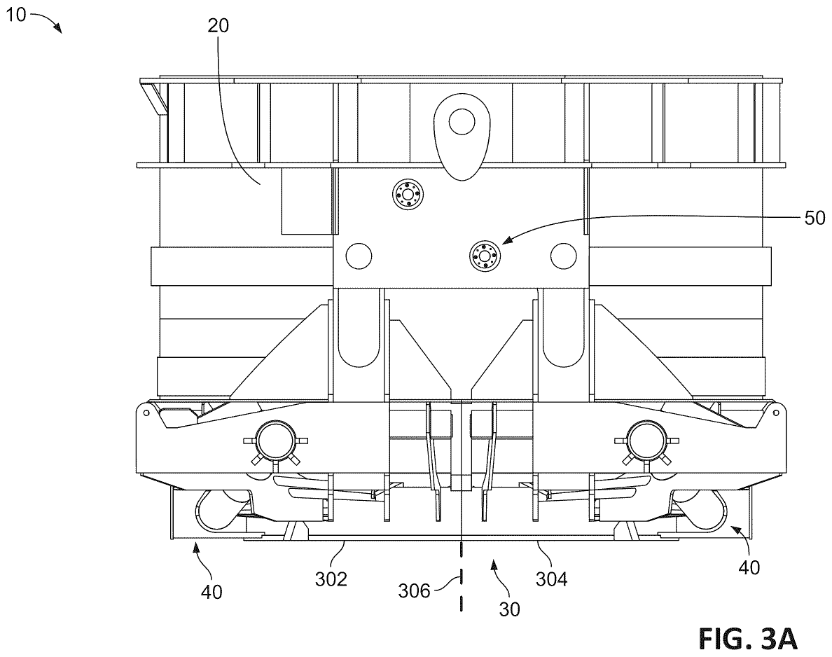

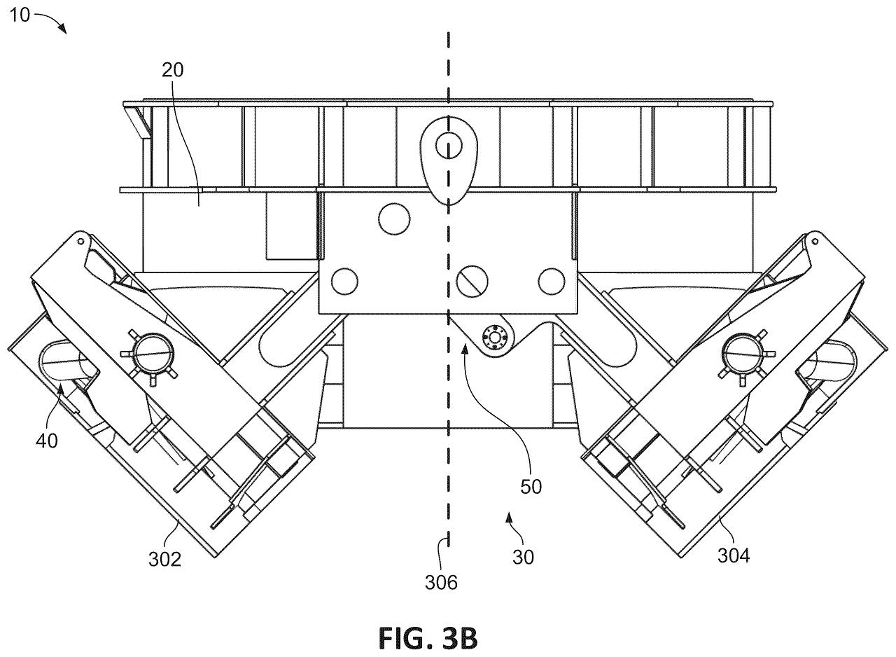

FIGS. 3A-B also illustrate an example scrap metal bucket of the present invention. FIG. 3A illustrates the example scrap bucket 10 of FIGS. 2A-B, shown in its first closed configuration. FIG. 3B illustrates the example scrap bucket 10 of FIGS. 2A-B, shown in its second open configuration. As illustrated in FIG. 3A, in an example, bucket 10 may further include clamshell bottom assembly 30. Clamshell bottom 30 may be comprised of first door 302 and second door 304. Clamshell bottom 30 may be movably and mechanically fastened to bucket 10 by linkage assembly 50, such that clamshell assembly may rotatably and pivotally move around bucket 10 from its first, closed position to its second, open position, as illustrated in FIG. 3B. Shown in FIG. 3A, in a first position, first door 302 and second door 304 may meet together at centerline 306 such that first door 302 and second door 304 form a closed bottom for scrap metal bucket 10.

FIG. 3B illustrates the example scrap bucket 10 of FIG. 2B, shown in a side elevational view. As illustrated in FIG. 3B, in an example, clamshell bottom 30 may rotatably and pivotally move around bucket 10 such that first door 302 and second door 304 rotate away from one another to create an opening at the bottom of scrap bucket 10. In the example embodiment and configuration, clamshell bottom 30 of bucket 10 is in an open position, where first door 302 and second door 304 of clamshell bottom 30 separate from centerline 306 of bucket 10. Linkage assembly 50 connecting first door 302 to sidewall 20 and connecting second door 304 to sidewall 20 may be configured such that first door 302 and second door 304 may separate from centerline 306 to the “open” position, shown in FIG. 3B.

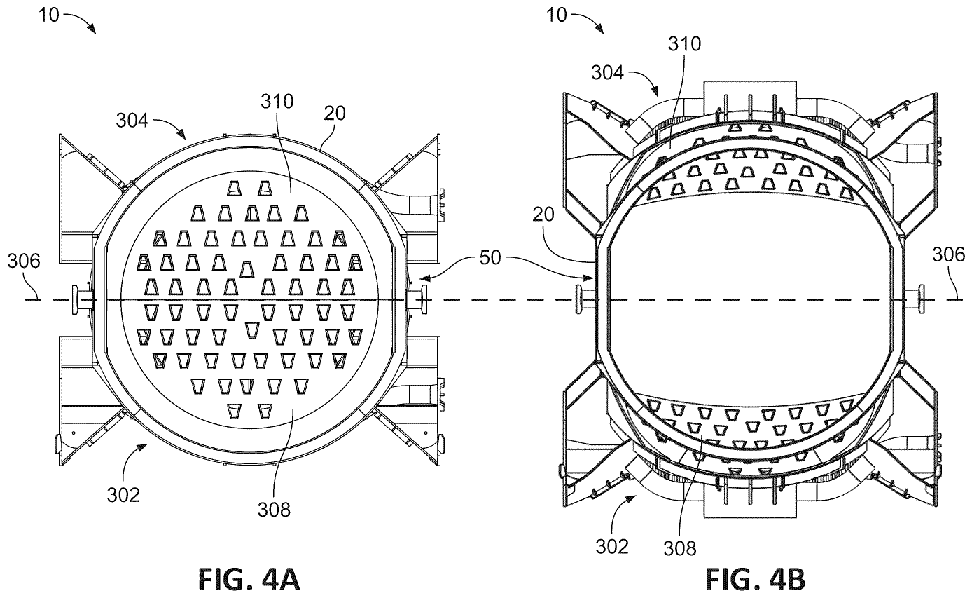

FIG. 4A illustrates the example scrap bucket 10 of FIGS. 2A-B, shown in a top plan view in the first closed configuration. FIG. 4B illustrates the example scrap bucket 10 of FIGS. 2A-B, shown in a top plan view in the second open configuration. As illustrated in FIG. 4A, in an example, first door 302 may have a first bottom plate 308, and second door 304 may have a second bottom plate 310 that is substantially the mirror image of first bottom plate 308, and which meet at centerline 306 in a first position to prevent material from falling out of the bottom of bucket 10. In the example embodiment and configuration, clamshell bottom 30 of bucket 10 is in its first, closed position, where first door 302 and second door 304 of clamshell bottom 30 meet at centerline 306 of bucket 10. Linkage assembly 50 connecting first door 302 to sidewall 20 and second door 304 to sidewall 20 may be configured such that first door 302 and second door 304 meet at centerline 306 in their “closed” positions. As seen in FIG. 4A, in the first closed configuration, 304 of bucket 10, clamshell halves 302, 304 meet at centerline 306 to form bottom 30 of bucket 10. First bottom plate 308 of first door 302 and second bottom plate 310 of second door 304 may be pivotally connected to sidewall 20 such that in the first position, first door 302 and second door 304, and specifically first bottom plate 308 and second bottom plate 310 are adjacent to the interior of sidewall 20 and form the interior of scrap metal bucket 10.

FIG. 4B illustrates the example scrap metal bucket in the second open position configuration. As seen in FIG. 4B, in the second open configuration, when a force, such as a pulling force on a chain connected to either door 302, 304 is applied to clamshell halves 302, 304, clamshell halves may rotate or pivot away from centerline 306, providing a hole in bottom 30 of bucket 10 through which scrap metal may pass and exit scrap metal bucket 10.

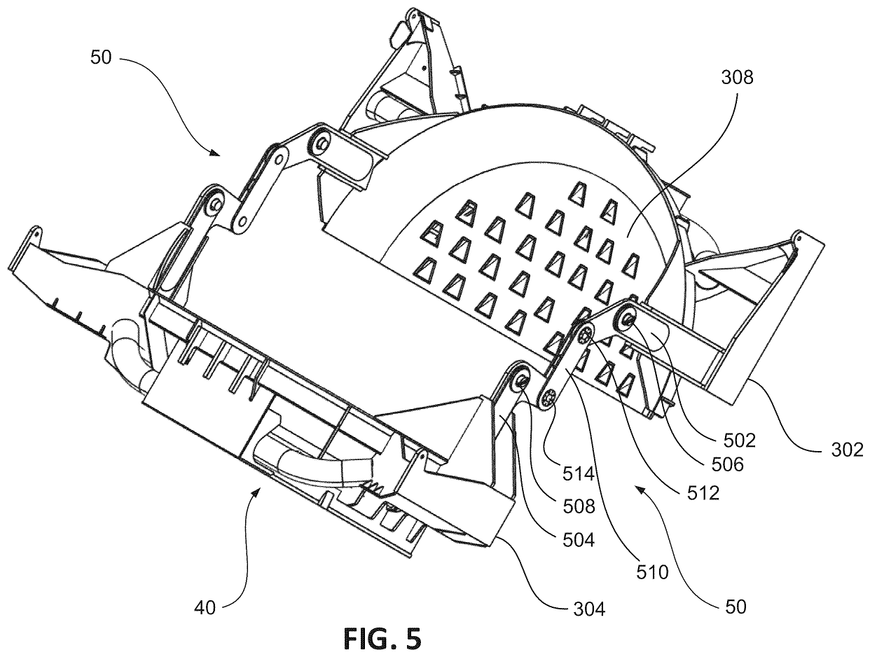

FIG. 5 illustrates the scrap metal bucket 10 shown in FIGS. 2A-B, in which scrap metal bucket 10 is shown in its second or open position. Shown in FIG. 5, scrap metal bucket 10 may further include a linkage assembly 50. Both first door 302 and second door 304 of clamshell assembly 30 may further include a first linkage arm 502, 504 on either side of first door 302 and second door 304. First linkage arm 502, 504 may be pivotally connected to scrap metal bucket 10, and specifically sidewall 20 (not shown here) of scrap metal bucket 10 at a first pivot point 506, 508. First door 302 and second door 304 may be linked to one another by spacer extension link 510 at a respective second pivot point 512, 514 on either or both of first linkage arm 502, 504 of either or both of first door 302 and second door 304, respectively.

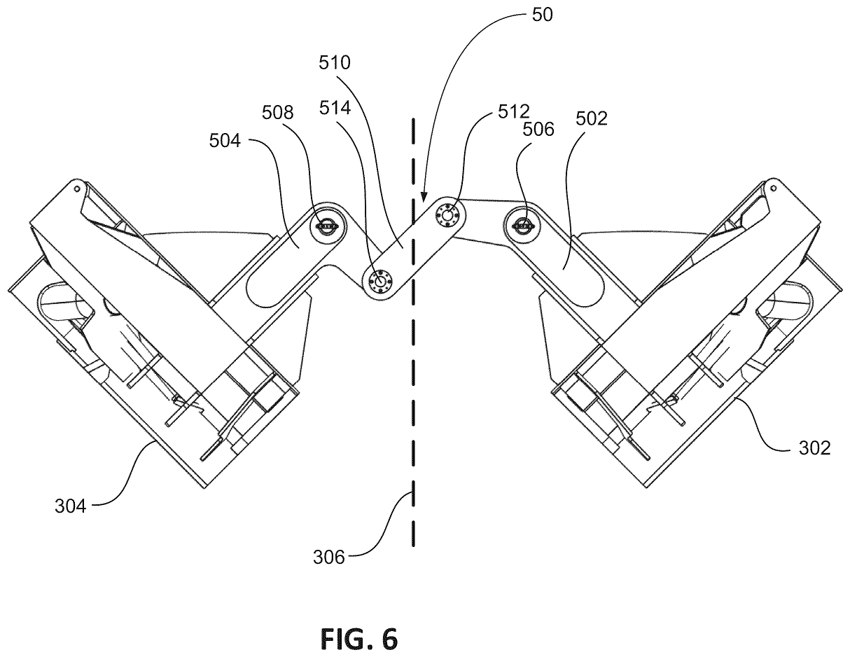

FIG. 6 illustrates a side elevational and partial view of scrap metal bucket 10 shown in FIGS. 2A-B, in which scrap metal bucket 10 is oriented in its second or open position. As shown in FIG. 6, in connecting first door 302 and second door 304 in this manner to scrap bucket 10 side wall 20 and also connecting first door 302 to second door 304 by spacer extension link 510, first door 302 and second door 304 may move simultaneously and may substantially mirror one another's movement, such that first door 302 and second door 304 open at substantially the same rate, mirroring the movement of the other door about centerline 306. Spacer extension link 510 enables first door 302 and second door 304 to separate to a greater distance apart from each other, thereby allowing for a larger “scrap-release” opening in scrap metal bucket 10. This may be accomplished by spacer extension link 510 pivoting about its central axis, thereby pushing first door 302 and second door 304 further apart.

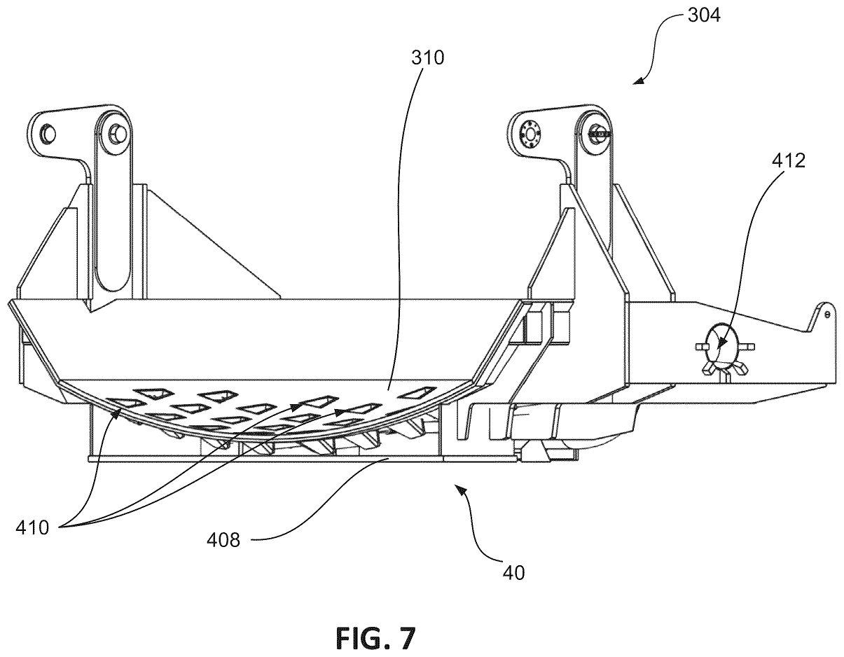

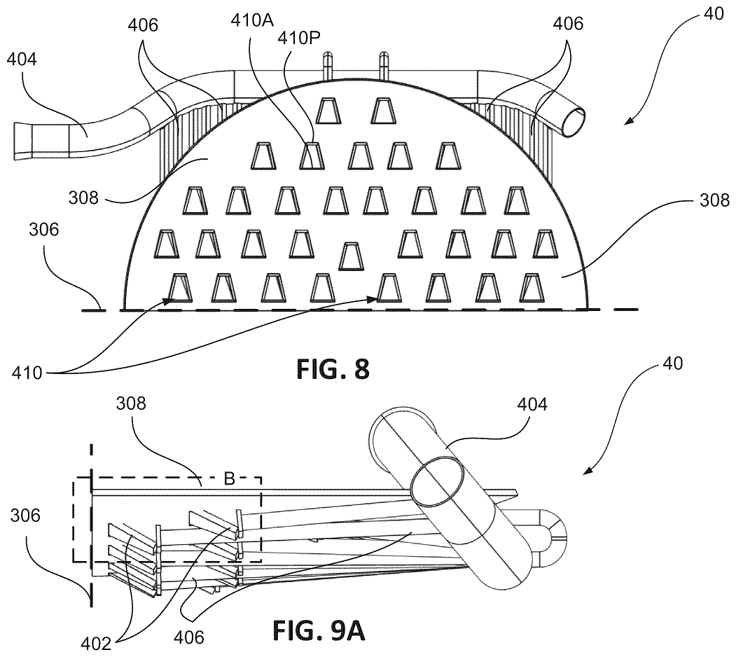

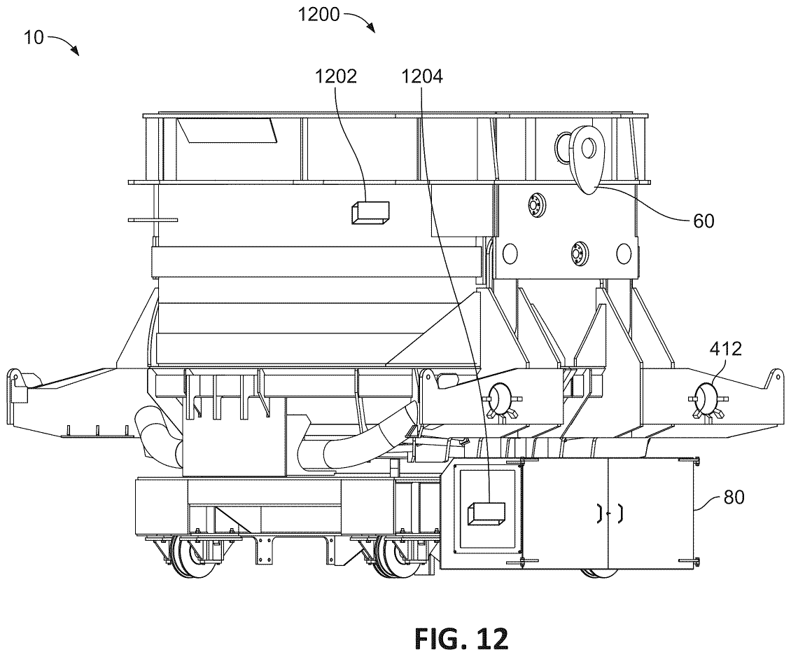

FIG. 7 illustrates a front perspective view of second door 304 of scrap bucket 10 shown in FIGS. 2A-B. As shown in FIG. 7, scrap metal bucket 10 may further include pre-heating and drying subassembly 40 attached to either or both of first door 302 and second door 304 of scrap metal bucket 10. Pre-heating and drying subassembly 40 may be installed by conventional mechanical fastening techniques and may be installed by welding or otherwise attaching the subassembly onto the first door 302 and/or second door 304, or may be integrally formed with first door 302 and/or second door 304. Pre-heating and drying subassembly 40 may be installed at the bottom or near the bottom of either or both of first door 302 and second door 304. In an example, first door 302 and second door 304 may have at least one, but as an example, a plurality of openings or apertures 410 cut from bottom plate 308 of first door 302 and/or bottom plate 310 of second door 304. Pre-heating and drying subassembly 40 may further include plate 408 located underneath apertures 410 of the first and second doors 302, 304 to provide a flat surface for scrap bucket 10 to rest on a scrap rail car, as shown in FIG. 12. Subassembly 40 with plate 408 also protects interconnected piping 406 from damage. See FIG. 8. In some embodiments, such as the one shown in FIG. 7 aperture 410 may be substantially trapezoidal in shape. In this example, the trapezoidal shape may be configured to have a wider end that is closer to the opening end of the first or second doors, 302, 304 to allow scrap metal that has been loaded into the bucket and gotten “caught” within an aperture in the closed configuration, to free itself from the bucket when reoriented to its “open” configuration by gravity, such as the open configuration of FIG. 4B. Pre-heating and drying subassembly 40 may further include port 412 to connect to a source of hot gas, hot air, or other high-temperature gases.

In the example illustrated in FIG. 7, second door 304 has a plurality of apertures 410 cut from bottom plate 310 of second door 304. A plurality of nozzles 402 may be positioned adjacent to apertures 410 and positioned underneath bottom plate 310. In an example, hot gas, or other gases may be fed through nozzles 402 and penetrate bottom plate 310 through apertures 410 to heat scrap metal located in scrap metal bucket 10.

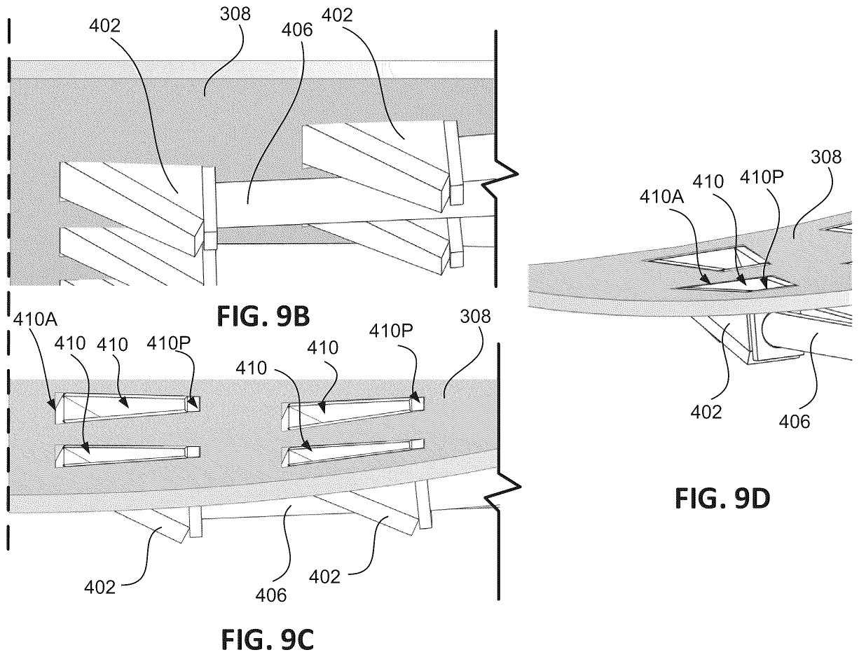

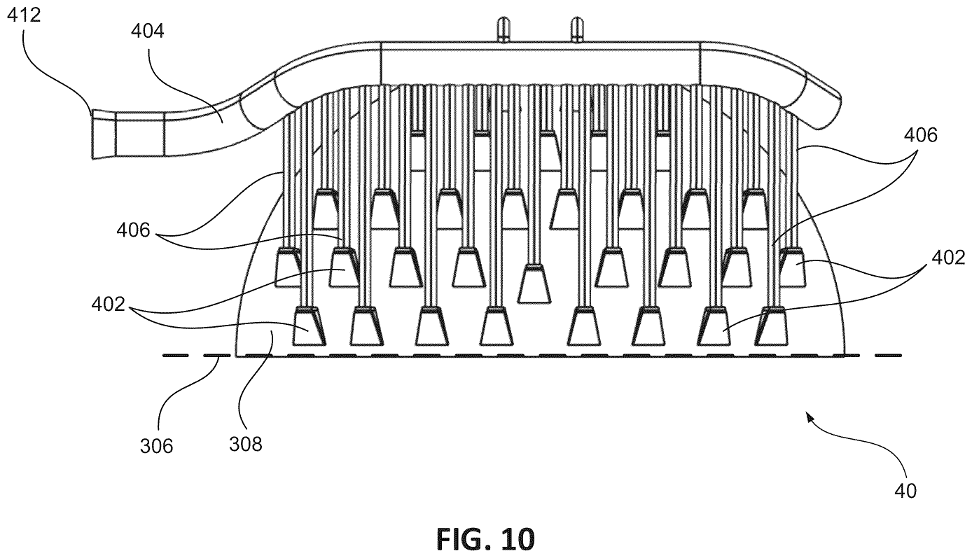

FIGS. 8-10 illustrate a partial detail view of the example scrap pre-heating and drying subassembly 40 as installed on scrap metal bucket 10 illustrated in FIGS. 2A-B. FIG. 8 is a top plan view of pre-heating and drying subassembly 40 in the first position. FIG. 9 is a side elevational view of pre-heating and drying subassembly 40 in the first position. FIG. 10 is a bottom plan view of pre-heating and drying subassembly 40 in the first position. FIGS. 8-10 illustrate pre-heating and drying subassembly 40 which may be, in an example, mechanically fastened to door 302, 304 in metal scrap bucket 10. As illustrated in FIGS. 8-10, pre-heating and drying subassembly 40 may also include at least one or in some cases a plurality of nozzles 402 connected to a gas feed line 404 via a plurality of tubes 406.

In FIG. 8, the example pre-heating and drying subassembly 40 of scrap metal bucket 10 illustrated in FIGS. 2A-B is shown in detail. Shown in FIG. 8, first door 302 and second door 304 may have at least one, but in the example illustrated, a plurality of apertures 410 located on first bottom plate 308 of first door and second bottom plate 310 of second door. Shown in FIGS. 8-9A, each aperture 410 may be connected to tube 406 by nozzle 402 as illustrated in FIG. 9. Each tube 406 is connected to gas feed line 404, which, in an example, may feed hot air or other hot gases into scrap bucket 10 (not pictured) via apertures 410 in first bottom plate 308 of first door 302 and second bottom plate 310 of second door 304 (not pictured).

In some embodiments, such as the embodiment illustrated in FIG. 8, aperture 410 may be substantially trapezoidal in shape. In the example, the trapezoidal shape may comprise an anterior edge 410A, and a posterior edge 410P. In the example, anterior edge 410A and posterior edge 410P may be substantially parallel to one another, and parallel to centerline 306. In the example, anterior edge 410A is closer to centerline 306 than posterior edge 410P for each trapezoidal shape. In the example embodiment, the trapezoidal shape may be configured to have a wider end that is further from nozzle 402 attachment point and closer to centerline 306 so as to allow scrap metal that is loaded into bucket 10 to fall freely towards centerline 306 when bucket 10 is in its “open” configuration, such as the configuration illustrated in FIG. 4B. That is, anterior edge 410A may be longer in length than posterior edge 410P of each trapezoidal aperture 410. In this manner, opening or aperture 410 of pre-heating and drying subassembly 40 may be cleared of scrap metal or other debris, which may be allowed to fall freely from the trapezoidal shape of opening 410 by gravity. In some embodiments, opening 410 may be circular in shape. In some embodiments, opening 410 may be in an alternative polygonal shape.

FIGS. 9B-9D illustrate the connection between tube 406, nozzle 402, and aperture or opening 410 in further detail. As shown in FIG. 9B, tube 406 connects directly to nozzle 402. Nozzle 402 is connected to aperture 410 from the bottom, or underside, of bottom plate 308, 310. Aperture 410 then opens to top surface of bottom plate 308, 310, such that gas is fed from underneath bottom plate 308, 310 through tubes 406, into the interior of scrap bucket 10. In an example, such as the example shown in FIG. 9B, nozzle 402 may attach to aperture 410 at all or substantially all perimeter locations of aperture 410, to form a fully enclosed connection between nozzle 402 and aperture 410 from a location on the underside of bottom plate 308, 310. All plates that make up nozzle assemblies 402 are welded to piping 406 to ensure that gas is forced through apertures, such as aperture 410 only, without leakage.

In the bottom perspective view shown in FIG. 9C, and in the rear perspective view shown in FIG. 9D, nozzle 402 may connect to aperture 410 at posterior edge 410P of aperture 410. Tube 406 may connect to nozzle 402 at a rear surface of nozzle 402, so that gas fed from tube 406 flows in a direction that is both upwardly, into the interior of scrap bucket 10, and toward anterior edge 410A of aperture 410, which may be in the direction of centerline 306 of clamshell door assembly 30.

As shown in FIG. 10, pre-heating and drying subassembly 40 may include a plurality of nozzles 402 fastened to first or second bottom plate 308, 310, of first or second door 302, 304, of clamshell bottom 30. Nozzle 402 may be attached to bottom plate 308, 310 of clamshell bottom 30 at an aperture or opening 410. Pre-heating and drying subassembly 40 may further include nozzle 402 connected to aperture 410, and tube 406 connected to nozzle 402 at each location of nozzle 402. Tube 406 may be mechanically fastened to nozzle 402 using fasteners, or may be fixed to nozzle 402 by welding, or by other mechanical processes. In some embodiments, not every nozzle 402 may have tube 406 attached, and thus nozzle 402 with no tube attached to it may be open, or exposed as a hole in door 302, 304 of clamshell bottom 30. In other embodiments, such as the embodiment illustrated in FIG. 10, each nozzle 402 has a tube 406 attached thereto. As an example, tubes 406 may connect to gas feed 404. In some embodiments, feed 404 may be substantially the same as tube 406, and in some embodiments feed 404 is larger in diameter or profile than tube 406. In some examples, multiple tubes 406 are each connected to separate nozzle 402, and all may connect to the same feed 404. Feed 404 may be connected to a source of gas, hot air, or other gases at port 412.

FIGS. 11A-11B show additional details of scrap drying and preheating subassembly 40. FIG. 11A shows the example scrap metal bucket 10 in its closed configuration. FIG. 11B shows the example scrap metal bucket 10 in its second open configuration. As an example, port 412 of feed 404 may be fastened to, or be otherwise supported by, first or second door, 302, 304, of clamshell bottom 30 of bucket 10. In an example, port 412 may be fastened to, or otherwise supported by linkage assembly 50 which connects first door 302 and second door 304 of clamshell bottom 30 together and may also be attached to sidewall 20 of bucket 10. As an example, first door 302 and second door 304 of clamshell bottom assembly 30 of scrap bucket 10 may also be in a first position, where first door 302 and second door 304 meet at centerline 306 and may articulate to provide a bottom for scrap bucket 10. In this example, scrap bucket 10 may be filled with scrap materials which may have been stored outside and which may be at cold, freezing, or below-freezing temperatures, with deposits of water snow or ice. Gas port 412 may be connected to an existing gas line by moving scrap bucket 10 near the location of an existing gas line and attaching gas port 412 by conventional coupling methods.

FIG. 12 is a front perspective view of the example scrap metal bucket 10 illustrated in FIGS. 2A-B, shown with an additional transport car 80. In an example, scrap bucket 10 may be moved by attaching moving or lifting machinery to lifting lugs 60 of scrap bucket 10. Scrap bucket 10 may then be placed on transport cart 80 which may allow for easier movement of scrap bucket 10, and allow for scrap bucket 10 to be moved to an existing gas line or source of hot air or other gas. An existing gas line may feed hot air or other gas to gas feed 404 through port 412. The hot air or gas may travel through gas feed 404 and into tubes 406 of heating subassembly 40. Hot air or gas may travel from tubes 406, through nozzles 402, and into scrap bucket 10 at the bottom via apertures 410 in first bottom plate 308 of first door 302 and second bottom plate 310 of second door 304. The hot gas or air may rise from the bottom of scrap bucket 10, as hot air or gas tends to rise above colder or ambient air.

As also shown in FIG. 12, scrap metal bucket 10 may further include control system 1200. Control system 1200 may include one or more sensors. In the example shown, sensor 1202 is a temperature sensor mounted on scrap metal bucket 10. In some examples, multiple sensors may be mounted at a plurality of locations on scrap metal bucket 10. In some examples, sensors may be one or more of temperature sensors, thermistors, thermocouples, or the like. Control system 1200 may further include a controller, such as controller 1204. As shown in the example, controller 1204 may be mounted on transport cart 80. Controller 1204 may control an amount and/or temperature of gases delivered to scrap metal bucket 10. Sensor 1202 sends a signal to controller 1204 to indicate when the contents of scrap metal bucket 10 have reached a sufficient temperature and/or have a sufficiently low moisture content. In response, controller 1204 stops the flow of gases to scrap metal bucket 10 and may send a signal or notification that the contents of scrap metal bucket 10 are sufficiently pre-heated and dry, and are ready for introduction into the EAF.

In the example, as the hot air or gas rise towards the top of scrap bucket 10, it may also warm the cold or freezing scrap materials inside of the bucket. When sufficient hot gas or air has been fed into bucket 10, to enable the scrap material stored in bucket 10 to reach a sufficient temperature, gas feed 404 may be disconnected from the existing gas feed line at port 412, and bucket 10 may be transported to an EAF for melting down the scrap contained therewithin. Linkage assembly 50 may be moved from a first position to a second position, which may move clamshell bottom assembly 30 from a first position to a second position in which first door 302 separates from second door 304 to open the bottom of bucket 10. Scrap drying and preheating assembly 40, which is fastened to and supported by either of first door 302 or second door 304 and thus connected to linkage assembly 50, likewise pivots or rotates in a rigid, fixed positional relationship with respect to first door 302 or second door 304. Thus, scrap pre-heating and drying subassembly 40 also moves from the bottom of scrap bucket 10 to provide an opening through which scrap metal may be displaced from scrap bucket 10, thus emptying the scrap contents of bucket 10 into a furnace. Contaminants may also be released out of either the top or the bottom of the clamshell before the scrap within the bucket is fed into the EAF, depending on whether the contaminants are evaporated out of the top of the bucket as a gas, or flow out of the bottom of the bucket as a released liquid.

In an example, bucket 10 may have at least one, and in an example, a plurality of temperature sensors to measure the temperature of materials stored inside bucket 10 in order to determine when materials inside of bucket 10 have reached an adequate temperature. Temperature sensors may signal to a controller the temperature of the pile of scrap metal contained within the scrap metal bucket, and controller may determine the amount and temperature of hot air or gas needed to be fed into the scrap metal bucket 10. In an example, scrap metal bucket 10 may further include at least one, and in an example several weight sensors which may determine the amount, by weight, of scrap metal contained within scrap metal bucket 10. Using both temperature readings from at least one temperature sensor, and weight measurements from at least one weight sensor, a controller may determine the amount and temperature of gas and duration of heating time an amount of scrap metal contained within scrap metal bucket 10 may need to be heated in order to reach a sufficient temperature to enter into an EAF.

In an example, pre-heating and drying subassembly 40 of bucket 10 may also include a debris and liquid collection component, which in an example may be installed onto catch plate 408, and which may collect and dispose of debris and liquids which may melt and otherwise collect at the bottom of bucket 10 during a heating operation. In an example, bucket may further include a fume hood located on top of bucket 10, which may collect the hot air or gas as it exits through the top of bucket 10 after heating the materials stored inside bucket 10.

The foregoing disclosure described systems and methods for conditioning metals, and in particular carbon steels, for introduction into an EAF. However, as will be appreciated by those skilled in the art, the systems and methods of the present disclosure may be applicable to other high temperature metal manufacturing processes (e.g., Al, FeNb, Si, FeSi, FeCr, Mn, FeMn, FeMo, FeV, Cu, Ni).

Thus, various embodiments, as described herein, provide systems and methods for melting ice and snow within a scrap metal bucket, evaporating pools of liquids within the scrap metal bucket, and for heating and drying scrap metal contained therewithin the scrap metal bucket. The systems and methods described herein may have applicability to other temperature-dependent manufacturing processes. These systems and methods are capable of conditioning materials, drying them and preheating them to a suitable temperature for introduction into an EAF, which enables better process control, which leads to higher quality steel.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references, unless the context clearly dictates otherwise. The meaning of “in” includes “in” and “on”, unless the context clearly dictates otherwise.

While various embodiments of the new technology described herein have been described in detail, it is apparent that modifications and adaptations of those embodiments will occur to those skilled in the art. However, it is to be expressly understood that such modifications and adaptations are within the spirit and scope of the presently-disclosed technology.

What is claimed is:

1. An apparatus for pre-heating and drying metal scrap contained within a metal scrap bucket utilized as part of a melting furnace process, the apparatus comprising:
a continuous housing having therewithin a contiguous side-wall;
a clam-shell base having a first door pivotably attached to the continuous housing adjacent said contiguous side-wall and a second door pivotably attached to the contiguous side-wall;
an interior defined by the contiguous side-wall and the clam-shell base; and
a plurality of nozzles positioned within the clam-shell base to enable the introduction of a heated gas into and through the scrap contained within the bucket to remove moisture, ice and snow from within the bucket, prior to the introduction of the scrap from the bucket into the melting furnace.

2. The apparatus of claim 1, further comprising:
a controller configured to direct and control an amount of said heated gas into the interior of the bucket from the plurality of nozzles.

3. The apparatus of claim 2, further comprising:
at least one temperature sensor configured to generate a signal indicative of a temperature of the interior wherein the controller commands the introduction and cessation of heated gas into the scrap bucket based on the generated signal.

4. The apparatus of claim 3, wherein the amount of gas commanded by the controller is based on a pre-determined amount of heating power.

5. The apparatus of claim 3, wherein the amount of gas commanded by the controller is configured to melt ice and snow within the interior of the bucket as well as to evaporate pools of liquids from therewithin.

6. The apparatus of claim 1, wherein an opening is associated with each of the plurality of nozzles, one or more of said openings in the interior being substantially trapezoidal in shape.

7. The apparatus of claim 6, wherein:
the clam-shell base comprises a center line defined by a meeting of the first door and the second door,
the opening of each of the plurality of nozzles has an anterior edge and a posterior edge, the anterior edge and the posterior edge being parallel and defined, relative to the center line, and
a length of the anterior edge being greater than a length of the posterior edge.

8. The apparatus of claim 2, wherein the amount and temperature of the gas introduced into the scrap bucket is insufficient to materially change the state of the metal scrap within the interior of the scrap bucket.

9. A method for pre-treating scrap, the method comprising:
loading a bucket with the scrap, the bucket comprising a base having a first door and a second door;
introducing, via at least one nozzle located in the base, an amount of hot gas into the bucket to evacuate moisture, snow, ice or water from within the bucket prior to releasing the scrap into a melting furnace;
positioning the bucket over a melting furnace; and
opening the first door and the second door to cause the scrap to fall into the furnace.

10. The method of claim 8, wherein the base is a clam-shell structure defined by the first door and the second door.

11. The method of claim 8, further comprising:
determining a temperature of the scrap via a temperature sensor; and
ceasing the introduction of the amount of hot gas based on attainment of the determined temperature.

12. The method of claim 8, wherein the amount of hot gas introduced into the scrap bucket is based upon a pre-determined amount of heating power.

13. The method of claim 8, wherein the amount of gas is configured to evaporate moisture and to melt ice and snow positioned within the bucket, while increasing the ambient temperature of the scrap metal within the scrap bucket.

14. The method of claim 8, wherein an opening of the at least one nozzle into the bucket is substantially trapezoidal in shape, in which the widest edge of the trapezoid faces downwardly upon opening of the clamshells.

15. The method of claim 8, wherein the amount of gas is insufficient to materially change the state of the scrap metal located within the interior.
